(19) United States
(12) Patent Application Publication
(10) Pub. No.: US 2025/0107666 A1
(43) Pub. Date: Apr. 3, 2025

(54) COFFEE GRINDER WITH REVOLUTION COUNTER UNIT

(71) Applicant: CONTI VALERIO – S.R.L., Sesto Fiorentino (FI) (IT)

(72) Inventor: Maurizio FIORANI, Milano (IT)

(21) Appl. No.: 18/897,156

(22) Filed: Sep. 26, 2024

(30) Foreign Application Priority Data
Oct. 3, 2023 (IT) 102023000020400

(51) Int. Cl. A47J 42/18; A47J 42/40; A47J 42/50

(52) U.S. Cl. CPC A47J 42/18; A47J 42/40; A47J 42/50

(57) ABSTRACT

A coffee grinder has an adjusting device suitable for adjusting a distance between the blades, an adjusting knob rotatably mounted on the body of the coffee grinder in such a way that a rotation of the adjusting knob determines an actuation of the adjusting device and consequently an adjustment of the distance between the blades, and a revolution counter unit mounted on the adjusting knob to count the revolutions of the adjusting knob and give an indication about the revolutions of the adjusting knob to the user.

### CROSS-REFERENCE TO RELATED APPLICATIONS

Not applicable.

### FIELD OF THE INVENTION

The present invention relates to a coffee grinder provided with an adjusting knob to adjust the distance between the blades and a revolution counter to count the revolutions of the adjusting knob.

### BACKGROUND OF THE INVENTION

Traditional coffee grinders comprise a hopper wherein coffee beans are fed. The coffee beans fall by gravity from the hopper into a grinding chamber arranged below the hopper.

A grinding unit is arranged in the grinding chamber. The grinding unit comprises two blades to grind the coffee beans and obtain coffee powder. The two blades are separated from each other in such a way to form a gap wherein the coffee beans are disposed in order to be ground.

A conveyor conduit communicates with the grinding chamber and with an outlet to dispense the ground coffee powder out of the coffee grinder. A receptacle, such as a filter holder, can be arranged under the outlet of the conveyor conduit to collect the coffee powder.

The distance between the two blades, that is, the width of the gap between the two blades, determines the particle size of the ground coffee.

The coffee grinders of the prior art comprise adjusting devices of the distance between the blades that allow for an axial displacement of a blade relative to the other blade.

The adjusting device comprises mechanical means, such as a nut-thread assembly, a toothed wheel-endless screw assembly, or a rod-tie assembly. Such mechanical means allow for a translation of one of the two blades along the axis of rotation of the blade, so as to bring the translating blade closer to or further away from the non-translating blade.

WO2019076871A1 and U.S. Pat. No. 7,874,505 describe examples of an adjusting device.

An adjusting knob can be manually rotated by the user to control the adjusting device that adjusts the distance between the blades.

The adjusting knob may have a graduated scale. In such a case, a pointer is provided on the body of the coffee grinder whereon the adjusting knob is mounted to indicate the rotation of the adjusting knob relative to an initial position.

It should be considered that the distance between the blades can be adjusted from a minimum value, wherein the two blades are in contact with each other, to a maximum value wherein the gap between the two blades has a width of about 2 mm.

However, in order to go from the minimum value to the maximum value, the adjusting knob must make more than one turn, usually three or four turns.

In such a case, the graduated scale of the adjusting knob indicates the angle of rotation of the knob relative to an initial position, but it does not indicate how many turns the knob has made. Therefore, by looking at the graduated scale of the adjusting knob, the user cannot understand whether the knob has made more than one turn.

The distance between the blades is set from time to time depending on the type of coffee beans and on the environmental parameters, such as humidity. The optimal distance between the blades is found only after performing several empirical tests on the ground coffee. Therefore, once the optimal distance between the blades is found, it becomes crucial for the user to memorize such an optimal distance correctly. For such a purpose, the user must know exactly how many turns the adjusting knob has made, otherwise the user cannot memorize the optimal distance that has been obtained after a considerable effort.

### SUMMARY OF THE INVENTION

The purpose of the present invention is to eliminate the drawbacks of the prior art by providing a coffee grinder that is capable of counting the revolutions of the adjusting knob.

Another purpose is to provide such a coffee grinder provided with a system capable of counting the revolutions of the adjusting knob that is efficient, accurate, reliable, economical, space-saving and versatile.

These purposes are achieved in accordance with the invention with the features of the appended independent claims.

Advantageous achievements of the invention appear from the dependent claims.

### BRIEF DESCRIPTION OF DRAWINGS

Further features of the invention will appear clearer from the following detailed description, which refers to a purely illustrative and therefore non-limiting form of its embodiment, illustrated in the appended drawings, wherein:

FIG. 1 is a diagrammatic side view of a coffee grinder according to the invention.

FIG. 2 is a perspective view of an upper part of the coffee grinder of FIG. 1 with an exploded view of a revolution counter unit.

FIG. 3 is the same view as FIG. 2, wherein the revolution counter unit is mounted on the adjusting knob.

FIG. 4 is an axial section view of FIG. 3 taken along the IV-IV section plane of FIG. 3.

FIG. 5 is an exploded perspective view illustrating the various parts of the revolution counter unit.

FIG. 5A is an enlargement of the revolution counter unit in FIG. 5.

FIG. 6 is a perspective bottom view illustrating a support bracket of the revolution counter unit.

FIG. 7 is a sectional view of the revolution counter unit in assembled condition.

FIG. 8 is an exploded sectional view illustrating the various parts of the revolution counter unit.

FIG. 9 is a bottom view of the revolution counter unit, wherein the indicator plate has been omitted.

FIG. 10 is a sectional view of the revolution counter unit according to a horizontal section plane, wherein the toothed wheel of the revolution counter and the shank with actuation tooth of the indication plate have been sectioned.

FIG. 11 is a top view illustrating the revolution counter mounted on an indicator plate.

FIG. 12 is a top view of the revolution counter unit in assembled condition.

### DETAILED DESCRIPTION OF THE INVENTION

With the aid of the Figures, the coffee grinder according to the invention is described, it being generally indicated with reference numeral 100.

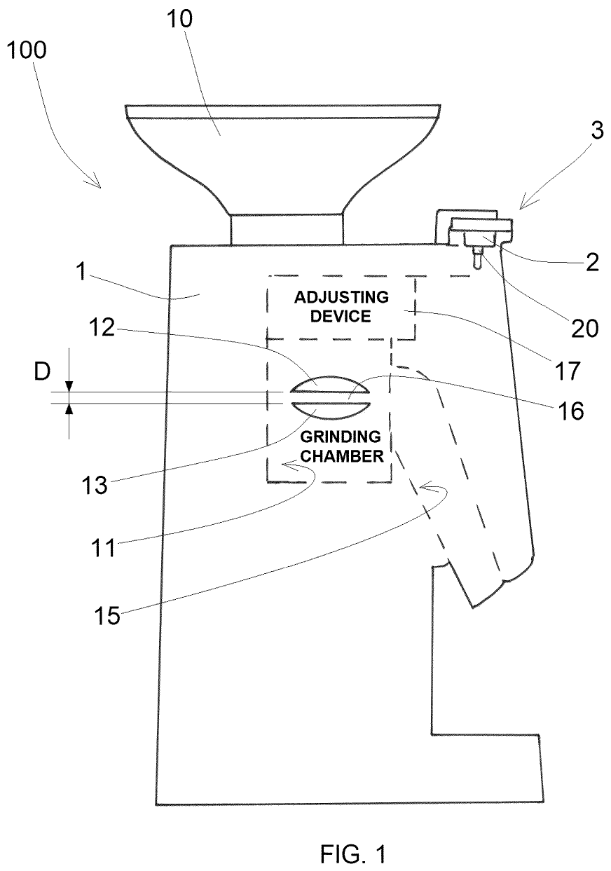

With reference to FIG. 1, the coffee grinder (100) comprises:
a body (1),
a grinding chamber (11) arranged in the body (1),
a hopper (10) arranged on the body (1) and communicating with grinding chamber (11),
two blades (12, 13) arranged in the grinding chamber to grind the coffee beans and obtain coffee powder, and
a conveyor duct (15) communicating with the grinding chamber (11) to dispense the ground coffee out of the coffee grinder.

A gap (16) with a width (D) that defines the distance between the blades, and thus the grain size of the ground coffee, is provided between the blades (12, 13).

At least one of the two blades is axially movable. In such a way the distance (D) between the blades and thus the grain size of the ground coffee can be varied.

An adjusting device (17) adjusts the distance (D) between the blades. Such an adjusting device is known and therefore is not described in detail.

An adjusting knob (2) is mounted on the body (1) of the coffee grinder in a position accessible to the user, so that it can be operated by the user to control the adjusting device (17) and thus adjust the distance (D) between the blades (12, 13).

The adjusting knob (2) is rotatable, and a rotation of the adjusting knob (2) determines an actuation of the adjusting device (17) and consequently an adjustment of the distance (D) between the blades.

The adjusting knob (2) is generally mounted in an upper wall of the body (1) of the coffee grinder and has a shaft (20) that extends vertically downward to drive a mechanism of the adjusting device (17).

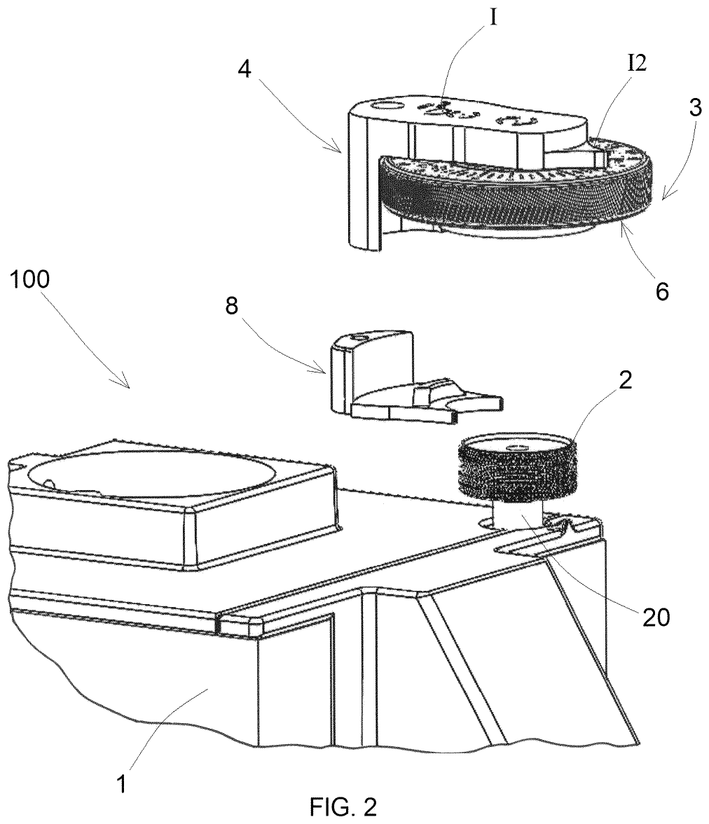

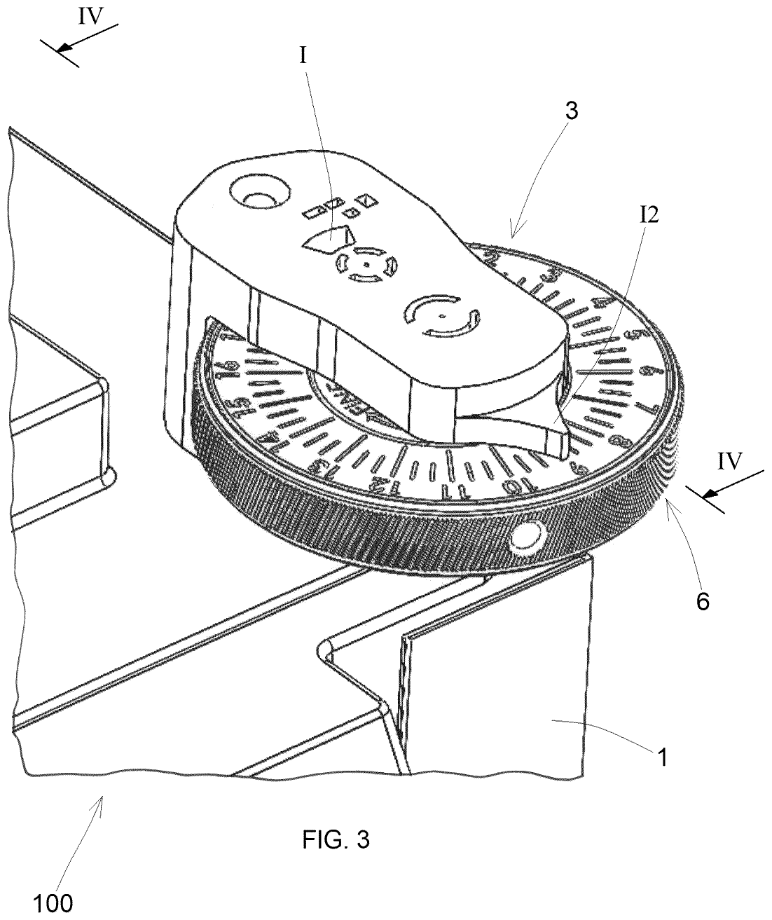

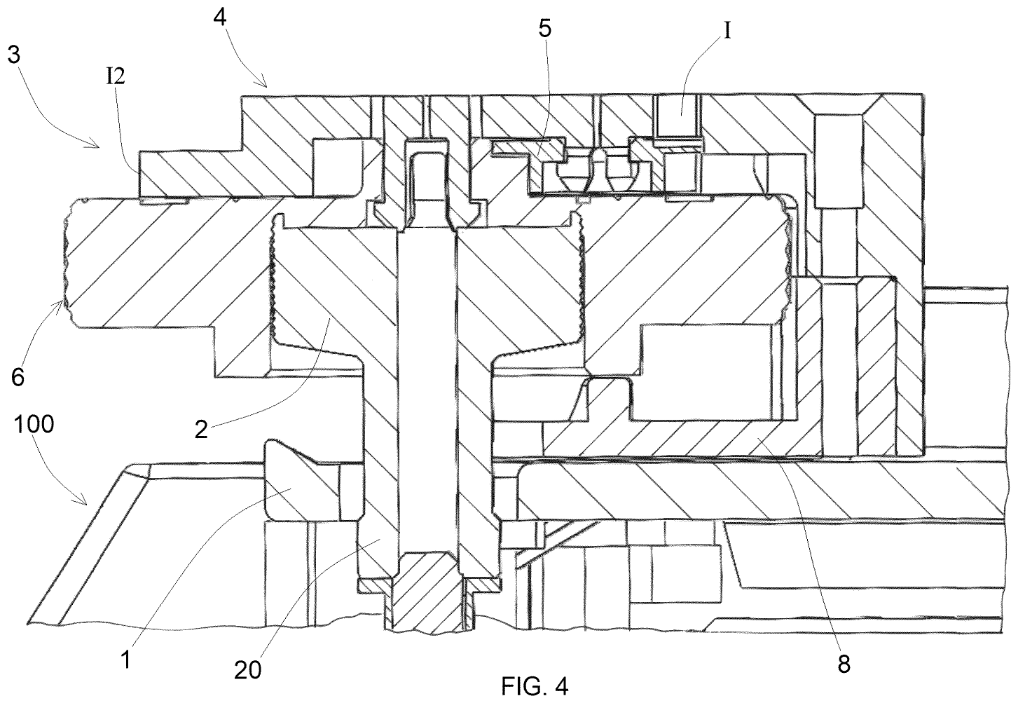

With reference also to FIGS. 2, 3 and 4, according to the invention, the coffee grinder (100) comprises a revolution counter unit (3) mounted on the adjusting knob (2) to count the revolutions of the adjusting knob and give an indication about the revolutions of the adjusting knob to the user.

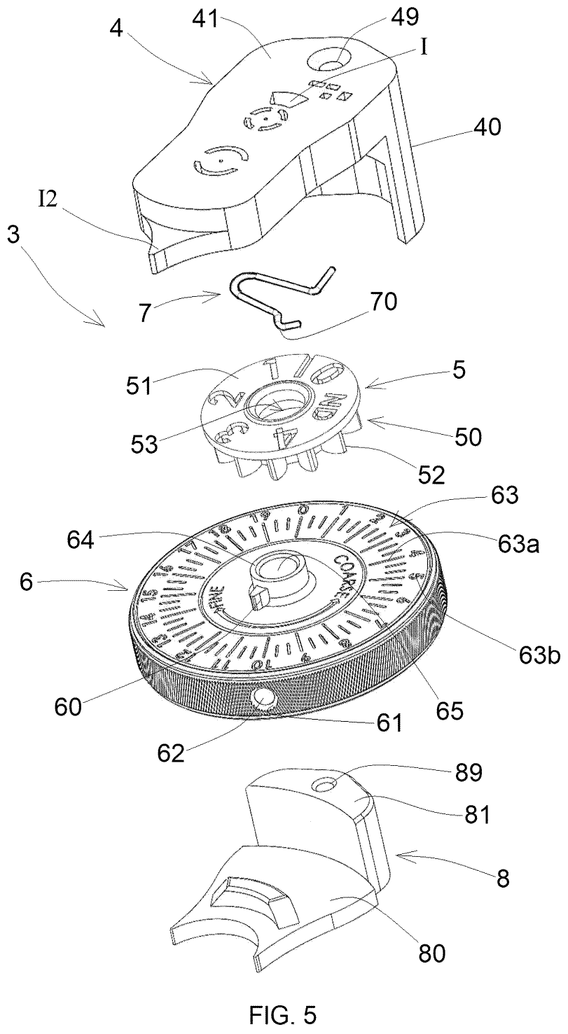

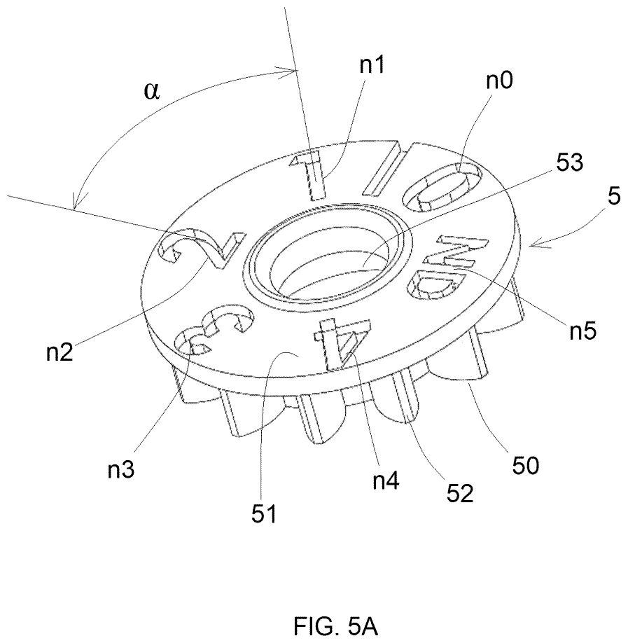

Referring to FIG. 5, the revolution counter unit (3) comprises:
a support bracket (4) mounted on the body (1) of the coffee grinder,
a revolution counter (5) mounted on the support bracket (4) near the adjusting knob (2), and
an actuation tooth (60) integral with the adjusting knob (2) and suitable for actuating the revolution counter (5) with each turn of the adjusting knob.

Preferably, the revolution counter (5) is of mechanical type. In such a case, the revolution counter (5) comprises a toothed wheel (50) rotatably supported by the support bracket (4) and a display plate (51) arranged on the toothed wheel.

The toothed wheel (50) comprises a plurality of teeth (52), e.g., the toothed wheel may comprise 10-14 teeth, preferably 12 teeth.

Referring to FIG. 5A, indications (n0, n1, n2, n3, n4, n5) on the number of revolutions are provided on the display plate (51) of the revolution counter, at a peripheral position.

The revolution counter unit (3) comprises an indicator (I) (shown on the support bracket (4)) that indicates one of the indications (n0, n1, n2, n3, n4, n5) of the revolution counter according on the number of revolutions made by the adjusting knob (2). The indicator (I) may be provided on the support bracket (4), or on the body (1) of the coffee grinder.

By way of example, six indications (n0, n1, n2, n3, n4, n5) respectively corresponding to the numbers 0, 1, 2, 3 and 4 and to the indication ND are provided on the display plate (51).

The indications (n0, n1, n2, n3, n4, n5) are angularly equidistant from each other by an angle (a). In the example shown in the figure, since there are six indications (n0, n1, n2, n3, n4, n5), they are angularly spaced by an angle (a) equal to 60°.

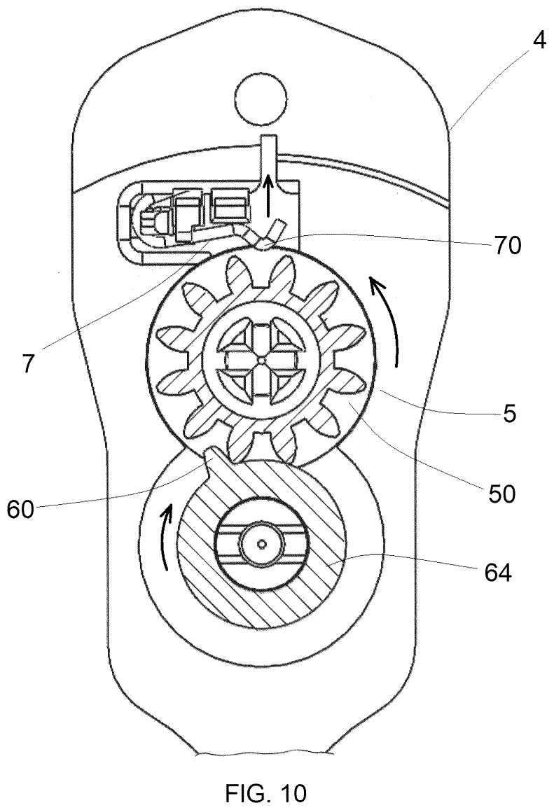

The number of teeth (52) of the toothed wheel of the revolution counter is such that, with each turn of the adjusting knob (2), the actuation tooth (60) engages with the teeth (52) of the toothed wheel (see FIG. 10) to have the toothed wheel (50) make a fraction of a turn equal to the angle (a) between the indications (n0, n1, n2, n3, n4, n5) of the display plate (51) of the revolution counter.

In the example shown in the figures, the toothed wheel (50) has twelve teeth (52), in such a way that, with each turn of the adjusting knob (2), the actuation tooth (60) moves two teeth (52) of the toothed wheel to have the revolution counter (5) make a rotation by an angle (a) of 60°.

In order for the toothed wheel (50) of the revolution counter to be locked in place after being pushed by the actuation tooth (60), the revolution counter unit (3) includes spring means (7) that act on the toothed wheel (50).

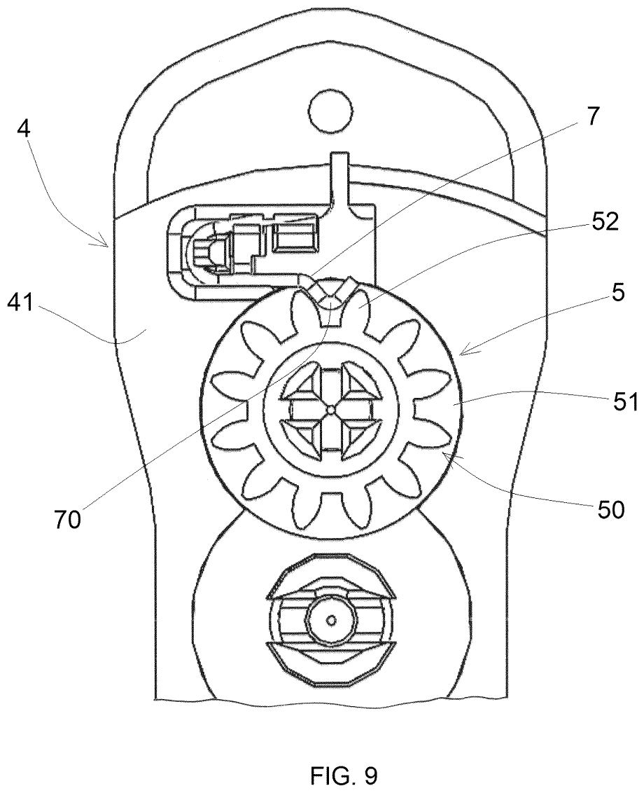

The spring means (7) are supported by the support bracket (4) and have a thrust portion (70) pushing on the toothed wheel. The thrust portion (70) of the spring has a U-shape such that it is arranged in a slot between two teeth (52) of the toothed wheel (FIG. 9). In such a way, the toothed wheel (50) rotates jerkily, so that the thrust portion (70) of the spring can consecutively enter and exit the slots between the teeth (52) of the toothed wheel. In the case shown in the Figures, the toothed wheel (50) makes two clicks for each turn of the adjusting knob (2).

The support bracket (4) has an L-shape comprising a side wall (40) and an upper wall (41) suitable for being disposed above the adjusting knob (2).

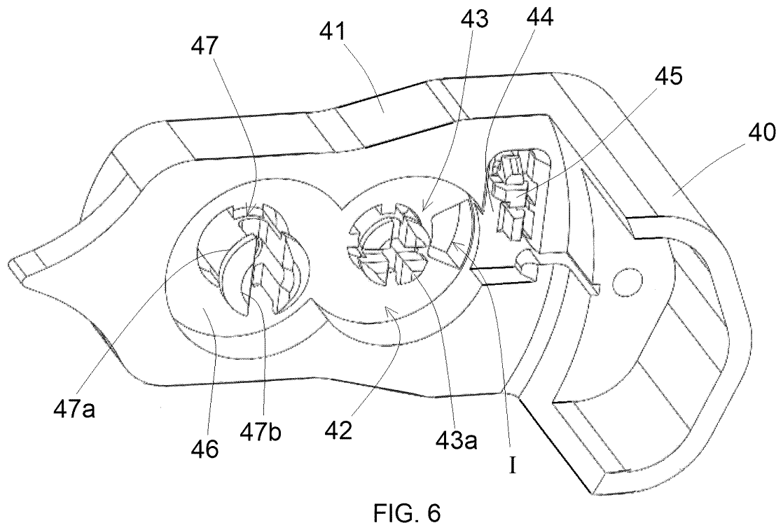

Referring to FIG. 6, in the upper wall (41) of the support bracket there is a first seat (42) facing downward to accommodate the revolution counter (5). In the first seat (42) of the support bracket, support means (43) are provided to rotatably support the revolution counter (5).

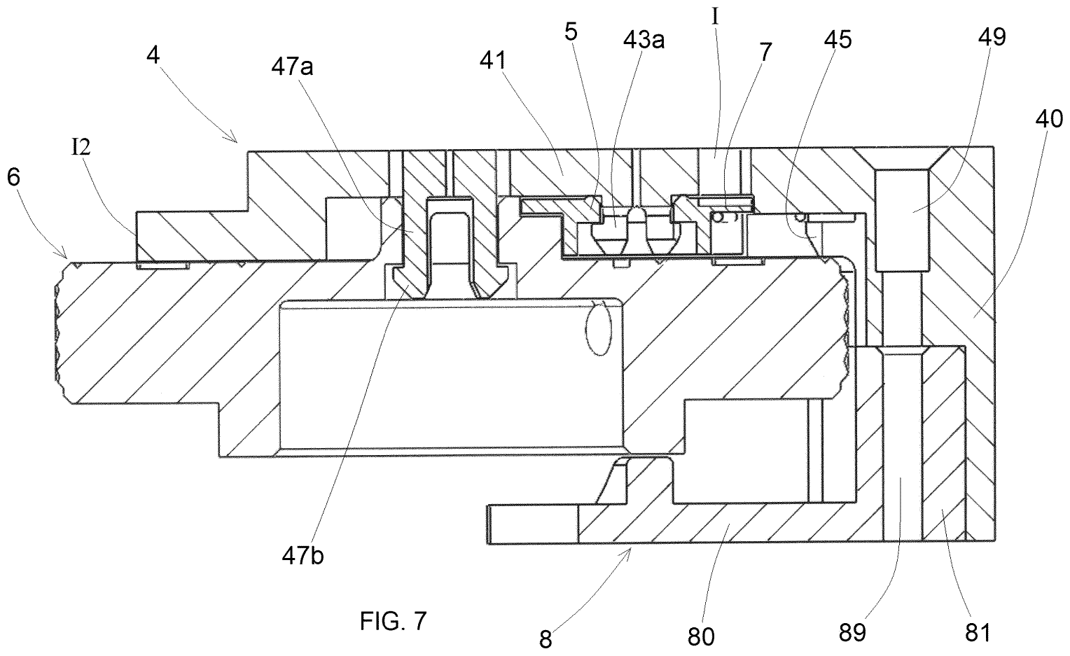

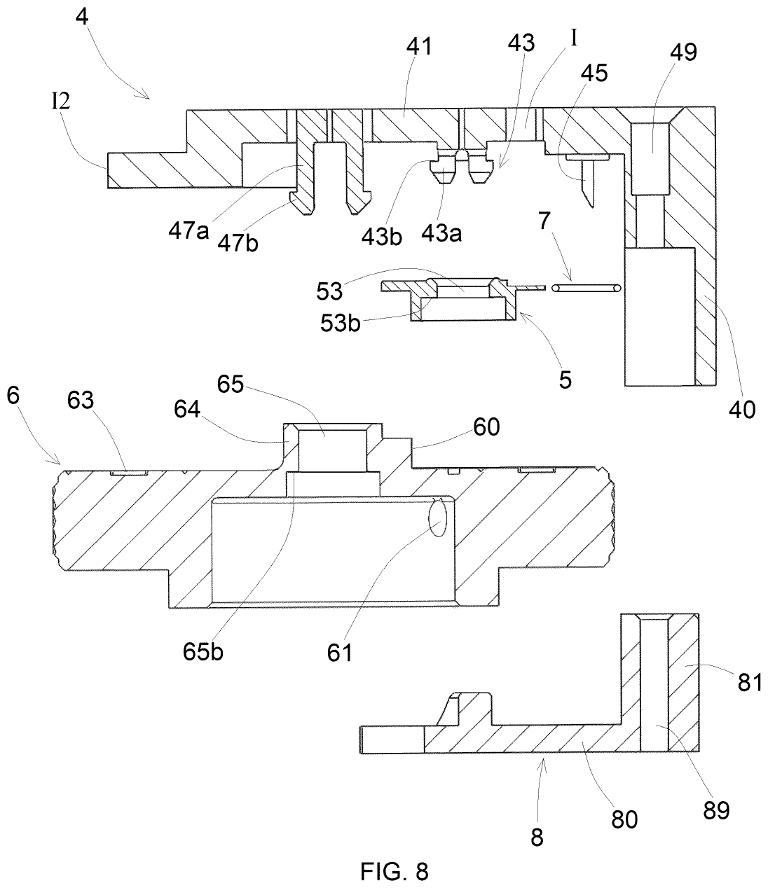

As also shown in FIGS. 7 and 8, the support means (43) are preferably elastic tabs (43a) that are snap-fitted into an axial hole (53) of the revolution counter. Specifically, each elastic tab (43a) has a retaining tooth (43b) that is stopped against a collar (53b) of the axial hole of the revolution counter.

In such a case, the indicator (I) is obtained as a window in the upper wall (41) of the bracket to let the user see only one among the indications (n0, n1, n2, n3, n4, n5) of the display plate (51) of the revolution counter.

With reference to FIG. 6, in the upper wall (41) of the support bracket there is a second seat (44) facing downward to accommodate the spring (7). In the second seat (44) of the support bracket, support means (45) are provided to support the spring (7). The spring (7) has a U-shape with the thrust portion (70) facing the toothed wheel (50) of the revolution counter.

Although the figures show a mechanical revolution counter, the revolution counter (5) may be an electronic revolution counter with a display to show the number of revolutions of the adjusting knob.

In the case of an electronic revolution counter, the revolution counter (5) may include an encoder with detection means capable of detecting the actuation tooth (60) integral to the adjusting knob (2), with each turn of the adjusting knob. In such a case, the actuation tooth (60) may be a magnet and the detection means may be a magnetic sensor. Alternatively, optical detection means suitable for detecting the actuation tooth (60) may be provided.

Returning to FIG. 5, advantageously, the revolution counter unit (3) comprises an indicator plate (6) whereon the actuation tooth (60) is provided. The indicator plate (6) is integrally mounted on the adjusting knob (2). For such a purpose, the indicator plate (6) has a radial hole (61) into which a nut (62) is screwed and engaged in the adjusting knob.

The indicator plate (6) has a graduated scale (63). The revolution counter unit (3) comprises a second indicator (12) (shown in the support bracket (4)) that indicates the graduated scale (63) of the indicator plate. The second indicator (12) can be arranged in the support bracket (4) or in the body (1) of the coffee grinder. As shown in the drawings, the second indicator (12) is a pointer disposed at one end of the upper wall (41) of the support bracket.

The graduated scale (63) of the indicator plate comprises a plurality of notches (63a) and numbers (63b) arranged peripherally and angularly equidistant. By way of example, the indicator plate (6) comprises sixty notches (63a) so as to indicate a rotation of the adjusting knob with an accuracy of 6°.

The indicator plate (6) has a central shank (64) that protrudes superiorly. The actuation tooth (60) protrudes radially from the central shank (64). An axial hole (65) runs axially through the central shank (64) of the indicator plate.

Referring to FIG. 6, in the upper wall (41) of the support bracket there is a third seat (46) facing downward to accommodate the center shank (64) of the indicator plate. In the third seat (46) of the support bracket there are fixing means (47) that protrude downward to enter the axial hole (65) of the indicator plate, as shown in FIGS. 7 and 8.

The fixing means (47) of the third seat of the support bracket are elastic tabs (47a) that are snap-fitted into the axial hole (65) of the display plate. Specifically, each elastic tab (47a) has a retaining tooth (47b) that is stopped against a collar (65b) of the axial hole of the display plate. In such a way, the indicator plate (6) can rotate, but it cannot translate axially.

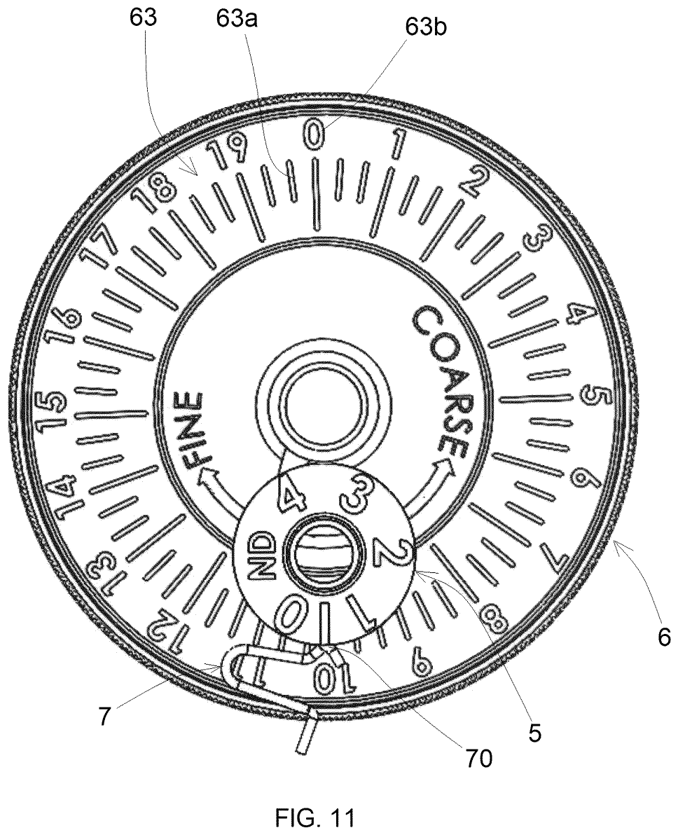

With reference to FIG. 11, the revolution counter (5) has a smaller diameter than the diameter of the indicator plate (6). For example, the revolution counter (5) has a diameter smaller than ⅓ of the diameter of the indicator plate (6). Thus, the revolution counter (5) can be disposed above the indicator plate (6), in a peripheral position relative to the center of the indicator plate.

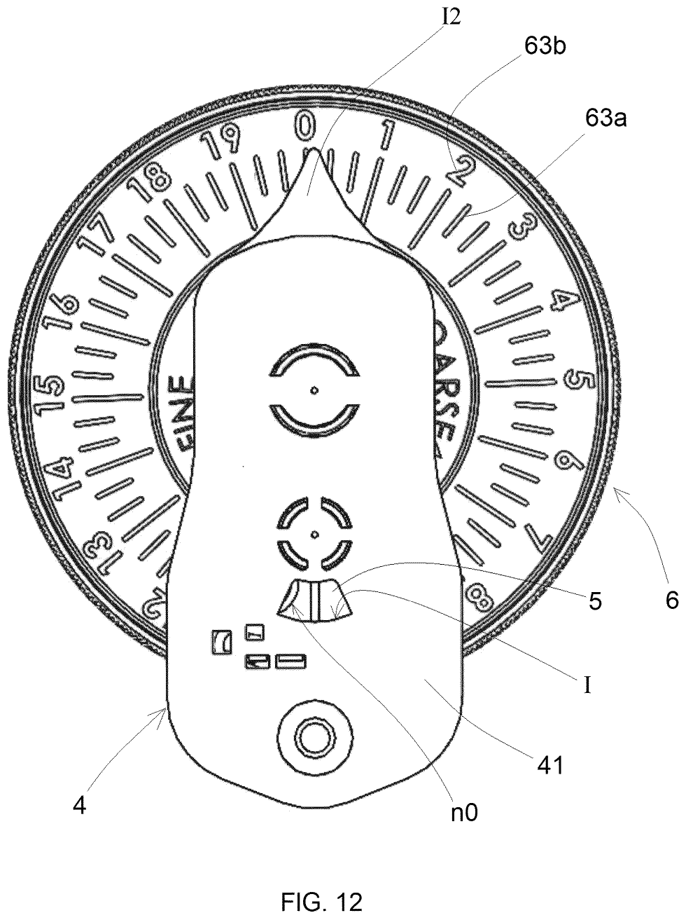

With reference to FIG. 12, the upper wall (41) of the support bracket totally covers the revolution counter (5). In such a way, only one indication, among the indications (n0, n1, n2, n3, n4, n5) of the revolution counter, can be seen through the indicator (I) of the support bracket (4), which consists of a window in the upper wall of the support bracket. The second indicator (12) in the form of a pointer at the end of the upper wall (41) of the support bracket (4) is located above the notches (63a) in correspondence with the numbers (63b) of the indicator plate (6) to point to a notch and a number of the graduated scale (63) of the indicator plate.

Referring to FIG. 5, the revolution counter unit (3) also comprises a base (8) whereon the support bracket (4) is mounted. The base has an L-shape and comprises a bottom wall (80) and a side wall (81). The side wall (40) of the support bracket is disposed on the side wall (81) of the base, so that the assembly comprising the revolution counter (5) and the indicator plate (6) is located between the bottom wall (80) of the base and the upper wall (41) of the support bracket.

Preferably, the support bracket (4) has a hole (49) that crosses the side wall (40) of the support bracket vertically and communicates with a hole (89) that crosses the side wall (81) of the base vertically. In view of the above, screw means may be arranged in the holes (49, 89) of the support bracket and of the base to fix the support bracket and the base. Evidently, different fixing means can be provided to fix the support bracket to the base.

The base (8) can be fixed on the body of the coffee grinder, for example, in a removable manner, such as by means of a double-sided adhesive tape disposed under the bottom wall (80) of the base.

Equivalent variations and modifications may be made to the present embodiment of the invention, within the scope of a person skilled in the art, which are nevertheless within the scope of the invention as expressed by the appended claims.

1. Coffee grinder comprising:
a body;
a grinding chamber arranged in the body;
a hopper arranged in the body and communicating with the grinding chamber;
two blades arranged in the grinding chamber to grind coffee beans and obtain coffee powder;
a conveyor duct communicating with the grinding chamber to dispense the ground coffee out of the coffee grinder;
an adjusting device suitable for adjusting a distance between the blades;
an adjusting knob rotatably mounted on the body of the coffee grinder in such a way that a rotation of the adjusting knob determines an actuation of the adjusting device and consequently an adjustment of the distance between the blades; and
a revolution counter unit mounted on the adjusting knob to count the revolutions of the adjusting knob and give an indication about the revolutions of the adjusting knob to the user.

2. The coffee grinder of claim 1, wherein said revolution counter unit comprises:
a support bracket mounted on the body of the coffee grinder;
a revolution counter mounted on the support bracket near the adjusting knob; and
an actuation tooth integral with the adjusting knob and suitable for actuating the revolution counter with each revolution of the adjusting knob.

3. The coffee grinder of claim 2, wherein said revolution counter is of a mechanical type.

4. The coffee grinder of claim 3, wherein said revolution counter comprises a toothed wheel rotatably supported by the support bracket and a display plate disposed on the toothed wheel.

5. The coffee grinder of claim 4, wherein said display plate of the revolution counter comprises indications of the numbers of revolutions disposed on the display plate at a peripheral position, and said revolution counter unit comprises an indicator indicating one of the indications of the revolution counter based on the number of revolutions made by the adjusting knob.

6. The coffee grinder of claim 5, wherein said indicator is a window provided on the support bracket.

7. The coffee grinder of claim 4, wherein the revolution counter unit comprises spring means acting on the toothed wheel of the revolution counter.

8. The coffee grinder of claim 7, wherein said spring means are supported by the support bracket and have a thrust portion pushing between the teeth of the toothed wheel.

9. The coffee grinder of claim 1, wherein said revolution counter unit comprises an indicator plate whereon said actuation tooth is disposed; said indicator plate being integrally mounted on the adjusting knob and said indicator plate having a graduated scale and said revolution counter unit having a second indicator indicating the graduated scale of the indicator plate.

10. The coffee grinder of claim 9, wherein the second indicator is a pointer at one end of said support bracket of the revolution counter unit.

11. The coffee grinder of claim 9, wherein the support bracket has an L-shape comprising a side wall and an upper wall suitable for being disposed above the adjusting knob; the upper wall of the support bracket comprises:
a first seat facing downward to accommodate the revolution counter and support means protruding from said first seat to rotatably support the revolution counter;
a second seat facing downward to accommodate the spring means and support means protruding from said second seat to support the spring means; and
a third seat facing downward to accommodate a central shank of said indicator plate and fixing means protruding from said third seat enter an axial hole of the central shank of the indicator plate.

12. The coffee grinder of claim 11, wherein the revolution counter unit comprises a base whereon the support bracket is mounted; said base having an L-shape and comprising a bottom wall and a side wall; the side wall of the support bracket being arranged on the side wall of the base, so that the assembly comprising the revolution counter and the indicator plate is located between the bottom wall of the base and the upper wall of the support bracket.

13. The coffee grinder of claim 2, wherein said revolution counter is of electronic type.
